(19) United States
(12) Patent Application Publication
(10) Pub. No.: US 2003/0029676 A1
(43) Pub. Date: Feb. 13, 2003

(54) Utility tray for step stool

(76) Inventors: William R. Gibson, Kent, OH (US); Enrique R. Giner, Beverly Hills, MI (US)

Correspondence Address: BARNES & THORNBURG, 11 SOUTH MERIDIAN, INDIANAPOLIS, IN, 46204

(21) Appl. No.: 09/935,813

(22) Filed: Aug. 23, 2001

Related U.S. Application Data
(63) Continuation of application No. 09/927,019, filed on Aug. 9, 2001.

(51) Int. Cl. E06C 1/00

(52) U.S. Cl. 182/161; 182/129

(57) ABSTRACT

A step stool includes a frame having legs movable relative to each other between an opened use position and a collapsed storage position. The frame includes an upper portion and a lower portion. A tray assembly is provided having a fixed tray mounted to the upper portion and a movable tray coupled to the fixed tray for movement relative to the fixed tray, the movable tray having an opened use position and a closed storage position.

### CROSS-REFERENCE TO RELATED APPLICATIONS

This application is a continuation of U.S. patent application Ser. No. 09/927,019, filed Aug. 9, 2001.

### BACKGROUND AND SUMMARY OF THE INVENTION

The present invention relates to a step stool, and particularly to a folding step stool including legs that fold between an opened use position and a collapsed storage position. More particularly, the present invention relates to a tray assembly used for storing or holding articles associated with the use of the step stool.

Step stools have a frame and one or more steps that individuals use for elevation when reaching for objects, painting walls, or any everyday task where extra elevation would be helpful. Step stool frames are often foldable for ease of storage while the step stool is not being used. Additionally, a tray assembly may be included to facilitate holding items.

According to the disclosure, a step stool includes a frame having legs movable relative to each other between an opened use position and a collapsed storage position. The frame includes an upper portion and a lower portion. A step is coupled to the lower portion. A tray assembly is provided having a fixed tray mounted to the upper portion and a movable tray coupled to the fixed tray for movement relative to the fixed tray, the movable tray having an opened use position and a closed storage position.

In the illustrative embodiment, at least one drawer is coupled to the tray. The drawer pivots between a closed position and an opened position, and has a stopper to prevent overextension of the drawer. Finger grooves are provided in the tray assembly for facilitating ascension and descension of a user.

Additional features of the invention will become apparent to those skilled in the art upon consideration of the following detailed description of preferred embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a step stool including a front leg, a rear leg coupled to the front leg in an opened use position, and a tray assembly coupled to an upper portion of the step stool frame;

FIG. 2 is a rear perspective view of the upper portion of the step stool of FIG. 1, showing the tray assembly including the fixed tray coupled to the upper portion of the step stool frame and the movable tray coupled for pivoting movement relative to the fixed tray;

FIG. 3 is a top view of the opened step stool of FIG. 1 showing the movable tray clasped in the vertical, closed position adjacent the fixed tray;

FIG. 4 is a front elevation view of the upper portion of the step stool of FIG. 3, showing the fixed tray having a vertically extending transverse wall disposed between left and right frame members, and showing a portion of the top surface of the movable tray when it is clasped in the vertical, closed position;

FIG. 5 is a top view of the tray assembly similar to that shown in FIG. 3, except that the movable tray has been unclasped from the vertical, closed position and pivoted to the opened, use position;

FIG. 6 is a bottom perspective view of the tray assembly of FIG. 5, showing the movable tray in the opened, use position and showing a drawer in the movable tray in a pivotably opened position;

FIG. 7 is a top perspective view of one of the drawers shown in FIG. 6, showing the storage basin, pivot axis, and detent formed to engage a tab and hold the drawer in the closed position;

FIG. 8 is a cross sectional view taken along line 8-8 of FIG. 6 showing a tab formed in the movable tray engaging the detent of the drawer shown in FIG. 7;

FIG. 9 is a sectional view taken along line 9-9 of FIG. 4, showing the movable tray in its closed position, clasped to a tubular frame member, and showing the clasp in broken lines in the non-clasped position, thereby readying the movable tray to be moved to an opened, use position;

FIG. 10 is a sectional view taken along the line 10-10 of FIG. 5, showing the movable tray in the opened, use position and showing the clasp assisting in the support of a can of paint (shown in phantom), and also showing the lock with portions broken away, the lock being configured to hold the movable tray in the opened position;

FIG. 11 is a sectional view taken along the line 11-11 of FIG. 10, showing the lip formed in one of the tabs of the lock, the lip engaging an edge formed in the fixed tray;

FIG. 12 is a sectional view of the lock taken along the line 12-12 of FIG. 10, showing tabs engaged with edges formed in the fixed tray;

FIG. 13 is a sectional view similar to that of FIG. 12, showing the tabs being disengaged from the edges formed in the fixed tray; and

FIG. 14 is a sectional view of the tabs coupled to the movable tray prior to their engagement with edges formed in the fixed tray.

### DETAILED DESCRIPTION OF THE DRAWINGS

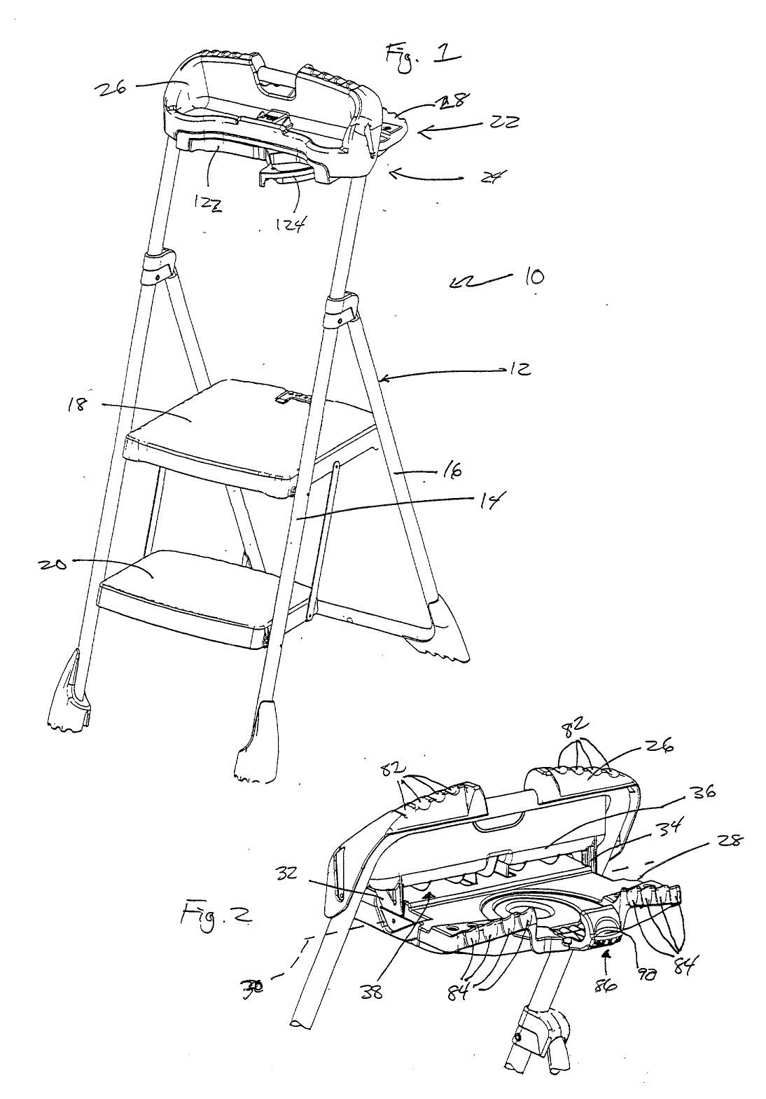

A foldable step stool 10 includes a frame 12 having a front leg 14, a rear leg 16, a top step 18, and illustratively a bottom step 20. Step stool 10 further includes a tray assembly 22 mounted on an upper portion 24 of frame 12, as shown in FIGS. 1-5. Tray assembly 22 includes a fixed tray 26 coupled to upper portion 24 of frame 12, and a movable tray 28 coupled to fixed tray 26 for pivotable movement relative to fixed tray 26.

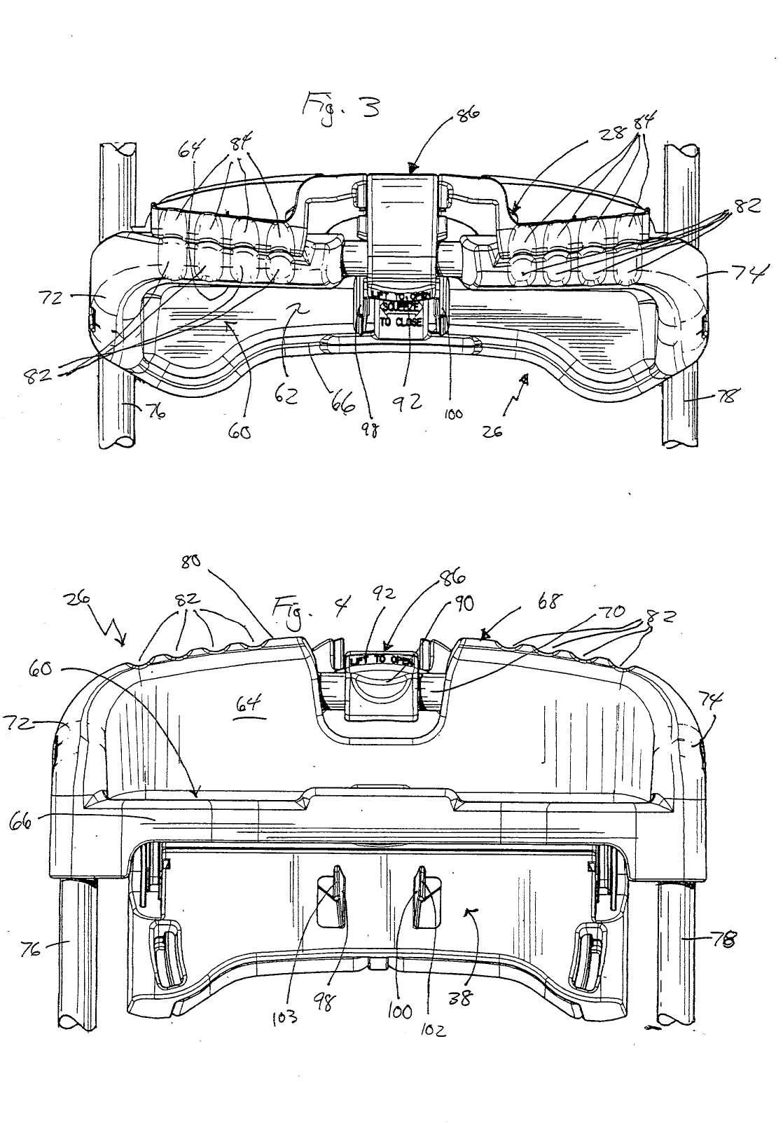

Movable tray 28 has an opened, use position as illustrated in FIGS. 1, 2, 5, 6, and 10, and a closed, storage position as illustrated in FIGS. 3, 4, and 9. In the use position, movable tray 28 extends substantially horizontally from fixed tray 26, as shown in FIGS. 1, 2, and 10. Movable tray 28 is coupled to fixed tray 26 for pivoting movement about axis 30, as shown in FIG. 2. Axis 30 passes through arms 32, 34, which are formed to extend from a rear surface 36 of fixed tray 26.

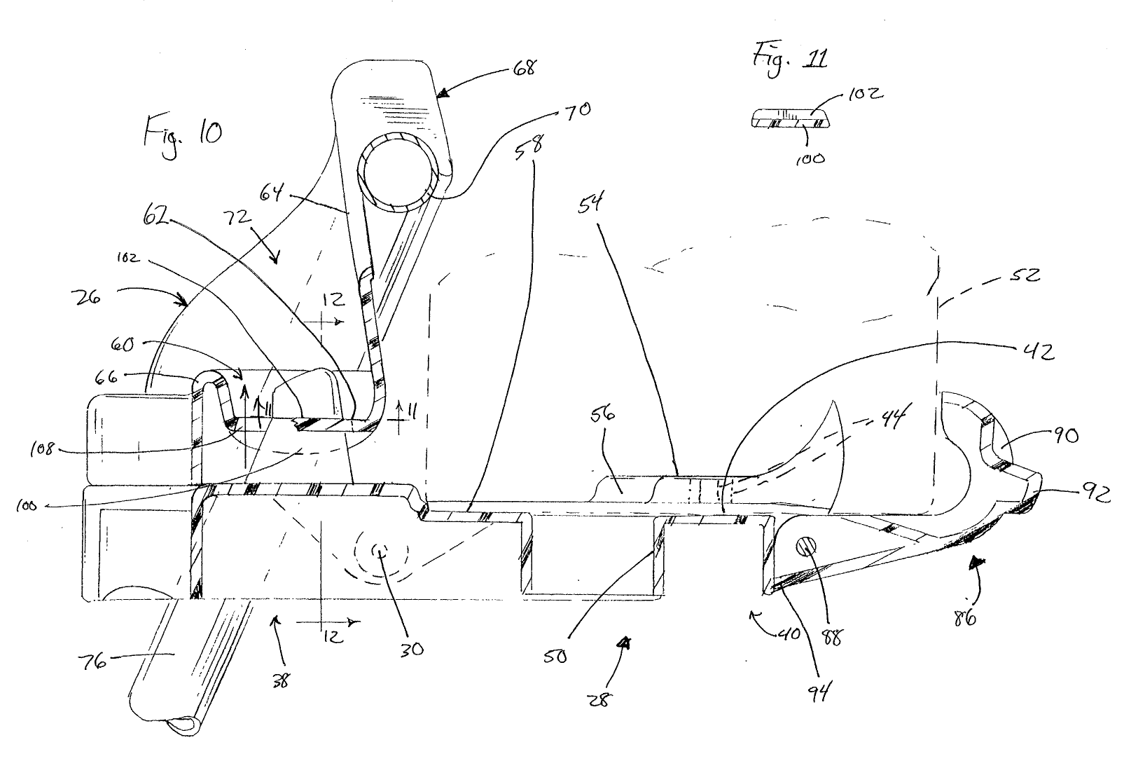

As movable tray 28 pivots about axis 30 from a storage position (shown in FIG. 9) to a use position as shown in FIG. 10, a mounting portion 38 of movable tray 28 engages fixed tray 26, while a distal portion 40 of movable tray 28 rotates about axis 30 to a position away from fixed tray 26, such that upper surface 42 of movable tray 28 extends substantially horizontally from fixed tray 26.

Movable tray 28 is formed to include apertures 44, as best seen from the top view of movable tray 28 in FIG. 5. Apertures 44 permit tools, such as screwdrivers, to be hung by their handles (not shown) from the apertures 44 and supported by upper surface 42 of movable tray 28. Apertures 44 are formed in the raised platform portion 54 of upper surface 42, as shown in FIGS. 5 and 10. Raised platform portion 54 includes an inner wall 56 which is formed to be slightly arcuate.

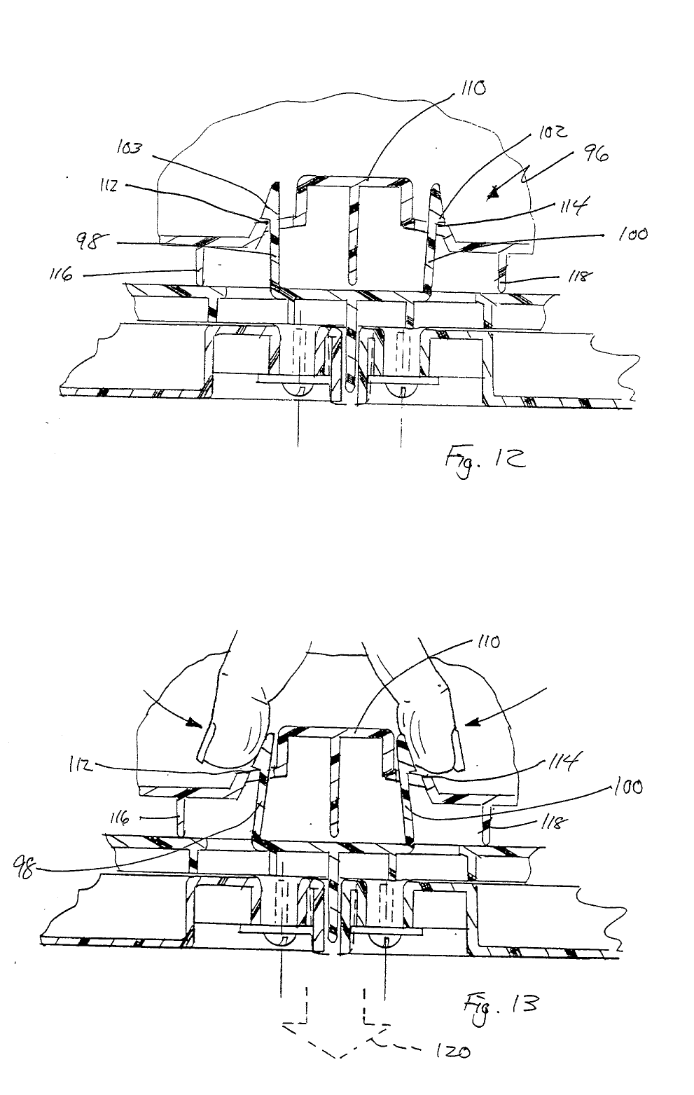

A lowered portion 58 of upper surface 42 is defined between inner walls 56 and mounting portion 38 of movable tray 28, as shown in FIG. 5. Lowered portion 58 of upper surface 42 includes receptors 46, 48, 50 for receiving and positioning, for example, the bottom rim of a can of paint 52 (shown in phantom in FIG. 11). Illustratively, receptors 46, 48 are indentions formed in upper surface 42 of movable tray 28, as shown in FIG. 5. Receptor 50 is a walled cylindrical aperture formed in movable tray 28, as seen from the side in FIG. 10.

Fixed tray 26 is formed to fit over upper portion 24 of frame 12 such that top portion 68 of fixed tray 26 engages upper transverse cross member 70 of frame 12, as shown in FIGS. 3-5 and 10. Additionally, fixed tray 26 includes side portions 72, 74 that engage side members 76, 78, respectively, of frame 12. Fixed tray 26 is formed to include a basin 60 having an upper surface 62, a rear wall 64, and a front rim 66, as can be seen in FIGS. 3-5 and 10.

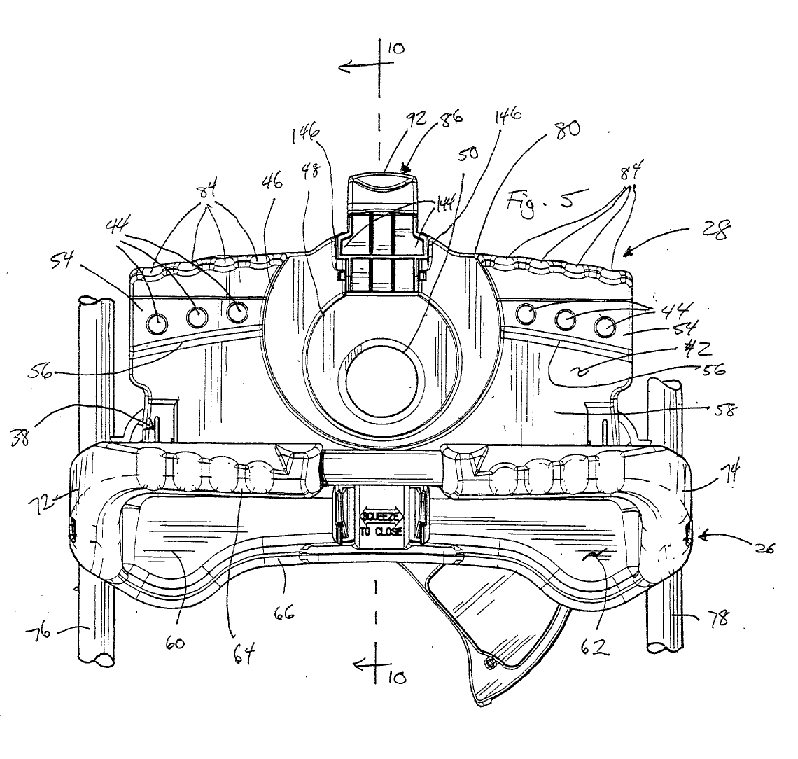

Top edge 80 of fixed tray 26 is formed to include finger grooves 82, as shown in FIGS. 4 and 5. Movable tray 28 also includes finger grooves 84, which are formed to align with finger grooves 82 when movable tray 28 is in the closed storage position adjacent fixed tray 26, as shown in FIG. 3. Finger grooves 82, 84 provide a convenient and comfortable position for a user to hold when ascending and descending step stool 10.

Movable tray 28 is moved and operated in substantially the following manner. Movable tray 28 is held in the closed storage position adjacent fixed tray 26 with a clasp 86, which is illustratively coupled to movable tray 28. It is within the scope of the disclosure, however, to have other means for holding movable tray 28 in the closed position, and it is similarly within the scope of the disclosure to couple such means to the fixed tray 26 or to the frame 12. In the illustrated embodiment, clasp 86 is configured to pivot about axis 88, shown in FIG. 10. Clasp 86 is formed to include a notch 90 for receiving the finger of an operator, thereby facilitating movement of the clasp 86. A tab 92 is formed adjacent notch 90, also facilitating movement of the clasp 86.

When movable tray 28 is in the closed storage position, clasp 86 is pivotable between an engaged position, shown in FIG. 9, and a disengaged position, shown in phantom in FIG. 9. In the engaged position, clasp 86 is formed to engage upper transverse hook cross member 70, thereby retaining movable tray 28 in the closed position. When clasp 86 is disengaged from cross member 70, movable tray 28 is freely movable between the closed storage position and the opened use position.

In the opened use position, as shown in FIGS. 5 and 11, clasp 86 is pivotable to a support position, where it is prevented from further pivoting movement by back edge 94 and tabs 144 of clasp 86 contacting movable tray 28. As can be seen in FIG. 5, tabs 144 fit in recesses 146 of movable tray 28 when clasp 86 is pivoted to the support position. In the support position shown in FIG. 10, clasp 86 is configured to cooperate with upper horizontal surface 42 of movable tray 28 to support items on the movable tray 28, for example, a paint can 52 (shown in phantom).

Movable tray 28 is locked in the use position shown in FIG. 10 with a lock 96, which removably secures mounting portion 38 of movable tray 28 to fixed tray 26 in the following manner. Lock 96 illustratively includes a set of two tabs 98, 100, each of which is formed to include a lip 103, 102 on a distal end 104 of the tab, as shown in FIGS. 3, 4, and 9-14. Illustratively, tabs 98, 100 with integral lips 103, 102 are configured to pass through slots 106, 108 formed in basin 60 of fixed tray 26, as can be best seen in FIG. 14. A central island 110 is molded in basin 60 of fixed tray 26 between slots 106, 108. As tabs 98, 100 approach slots 106, 108, as shown in FIGS. 4 and 14, lips 103, 102, engage rims 112, 114 of slots 106, 108, respectively, to lock the movable tray 28 in the use position, such that the lock 96 appears as shown in FIG. 12. It should be understood, however, that lock 96 could alternately comprise any other means known in the art for maintaining the movable tray 28 in the opened use position.

As tabs 98, 100 approach the engaged position shown in FIG. 12, ribs 116, 118 (in cooperation with other elements of fixed tray 26 and movable tray 28) prevent the over-insertion of tabs 98, 100 into slots 106, 108. Movable tray 28 becomes “locked” in the use position when lips 103, 102 pass rims 112, 114 of slots 106, 108, and move (from pressure provided by the formed tabs 98, 100 returning to their natural position) over the tops of rims 112, 114.

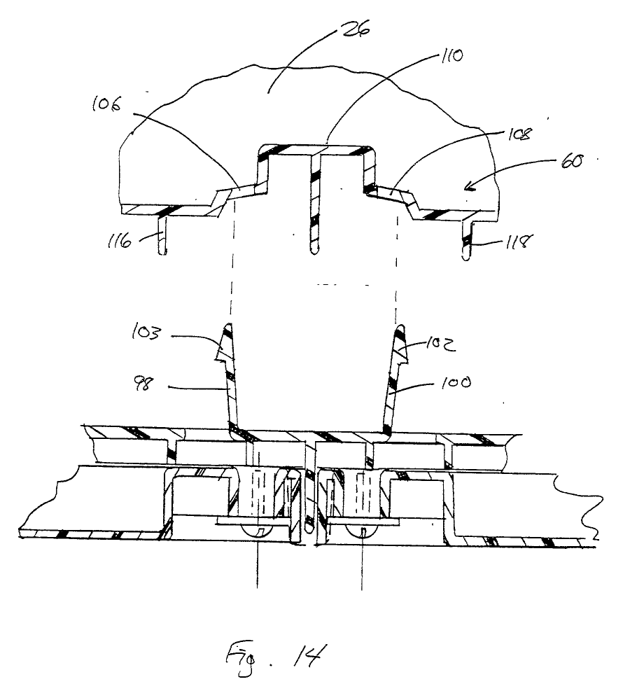

In order to disengage lock 96, finger pressure, as shown in FIG. 13, is applied to tabs 98, 100, directing them toward central island 110. Such pressure releases lips 103, 102 from rims 112, 114, thereby allowing tabs 98, 100 to be pulled back through slots 106, 108 when movable tray 28 is moved toward the closed storage position, and mounting portion 38 of movable tray 28 moves in the direction indicated by arrow 120.

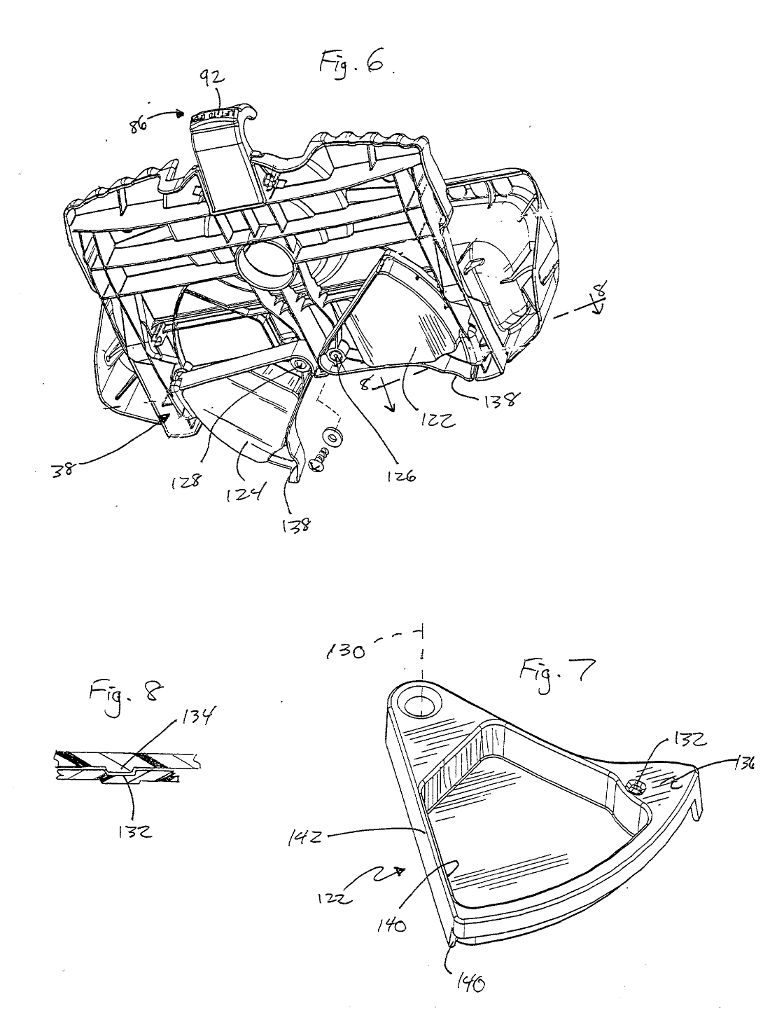

In the illustrative embodiment, movable tray 28 is further configured to include two drawers 122, 124 formed to be pivotably opened toward a step stool user when the user is standing on one of the steps 18, 20. Drawers 122, 124 move with the movement of movable tray 28. Therefore access is configured to be easiest when movable tray 28 is in the opened use position, as shown in FIG. 1. In such a position, drawers 122, 124 pivot about an axis 130 formed by fasteners 126, 128, as shown in FIGS. 6 and 7.

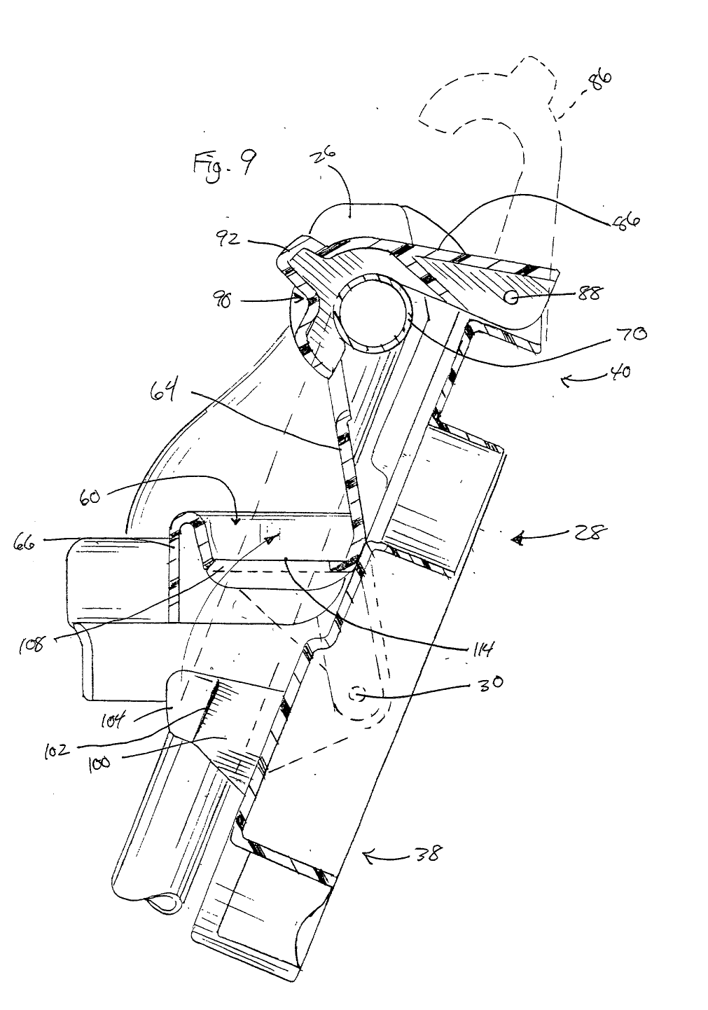

Drawers 122, 124 engage movable tray 28 and are retained in position under movable tray 28 with a tab and detent system, as shown in FIG. 8. Detent 132 is illustratively formed in top surface 136 of drawer 122, while tab 134 is formed in movable tray 28 such that drawer 122 is retained in the closed position until force is applied by a user.

Drawers 122, 124 further include finger recesses 138 formed to facilitate the movement of drawers 122, 124 by a user between the open and closed position. Additionally, a stopper is used to prevent overextension of drawers 122, 124 from movable tray 28. Illustratively, movable tray 28 includes a tab (not shown) associated with each drawer, the tab contacting an inside surface 140 of rear wall 142 (shown in FIG. 7) of drawers 122, 124 when drawers 122, 124 are extended to the opened position.

Although the invention has been disclosed in detail with reference to certain preferred embodiments, variations and modifications exist within the scope and spirit of the invention as described and defined in the following claims.

What is claimed is:

1. A step stool comprising
a frame having legs movable relative to each other between an opened use position and a collapsed storage position,
a step coupled to the frame,
a tray comprising a mounting portion and a distal portion, the tray being movable between a storage position and a generally horizontal use position, and
at least one drawer coupled to the tray for pivotal movement between a closed position and an opened position.

2. The step stool of claim 1, wherein the drawer is configured to extend from a closed position underneath the tray when the tray is in its use position to a pivotably extended position away from the tray.

3. The step stool of claim 2, wherein the drawer includes a stopper for stopping the drawer when it reaches the extended position.

4. The step stool of claim 1, wherein the drawer is formed to include a bottom, the bottom having a finger recess for facilitating movement of the drawer relative to the tray.

5. The step stool of claim 1, wherein the tray defines an upper horizontal surface when the tray is in the use position, the upper horizontal surface defining a plurality of receptors for holding differently sized cans of paint on the upper horizontal surface.

6. The step stool of claim 1, further comprising a lock for positively locking the tray in the use position.

7. The step stool of claim 6, wherein the lock comprises a tab and a catch, the tab being coupled to the tray and the catch being coupled to the frame.

8. The step stool of claim 7, wherein the tab is configured to be disengaged from the catch with the application of lateral pressure.

9. The step stool of claim 1, wherein the tray comprises a perimeter, the perimeter being formed to define finger grooves.

10. The step stool of claim 1, wherein the drawer is configured to pivot from substantially the center of the tray.

11. The step stool of claim 1, wherein the at least one drawer is a pair of drawers.

12. A step stool comprising
a frame having legs movable relative to each other between an opened use position and a collapsed storage position, the frame including an upper portion,
a step coupled to the frame, and
a tray assembly having a fixed tray mounted to the upper portion and a movable tray coupled to the fixed tray for movement relative to the fixed tray, the movable tray having an opened use position and a closed storage position.

13. The step stool of claim 12, wherein the upper position of the frame has a transverse cross member and the fixed tray is mounted on the transverse cross member.

14. The step stool of claim 12, wherein the fixed tray is formed to include a transversely extending horizontal support surface and an upwardly and transversely extending wall disposed between the horizontal support surface and the frame.

15. The step stool of claim 12, wherein the movable tray is configured to pivot relative to the fixed tray between the use position and the closed storage position.

16. The step stool of claim 12, wherein the movable tray and fixed tray combine to define a common upper perimeter when the movable tray is in the closed position.

17. The step stool of claim 16, wherein the upper perimeter is configured to include finger grooves defined by both the movable tray and the fixed tray.

18. The step stool of claim 12, further comprising a drawer pivotably coupled to the movable tray.

19. The step stool of claim 18, wherein the movable tray, in its opened position, forms a platform on one side of the fixed tray and the drawer is configured to extend from a closed position underneath the fixed tray to an extended position on an opposite side of the fixed tray.

20. The step stool of claim 12, further comprising a clasp coupled to the tray assembly and configured to hold the movable tray in the closed storage position.

21. The step stool of claim 20, wherein the clasp engages the frame to hold the movable tray in the closed storage position.

22. A step stool comprising
a frame having legs movable relative to each other between an opened use position and a collapsed storage position, the frame including an upper portion,
a step coupled to the frame,
a tray assembly having a fixed tray mounted to the upper portion and a movable tray coupled to the fixed tray for movement relative to the fixed tray, the movable tray having an opened use position and a closed storage position, and
a clasp configured to hold the movable tray in the closed storage position.

23. The step stool of claim 22, wherein the movable tray pivots relative to the fixed tray such that the movable tray is adjacent the fixed tray when in the closed storage position, and the movable tray has a portion that extends away from the fixed tray when in the opened use position.

24. The step stool of 22, wherein the clasp is pivotably coupled to the movable tray, and the clasp is configured to pivot to a position where it detachably engages the frame and holds the movable tray in the storage position.

25. The step stool of 24, wherein the frame is configured to have an upper transverse cross member and the fixed tray is configured to form a sleeve around the upper portion of the frame with an opening to expose a central portion of the cross member, the clasp engaging the central portion to hold the movable tray in the storage position.

26. The step stool of claim 22, wherein the clasp and movable tray are configured to cooperatively hold a paint can when the movable tray is in the use position.

27. The step stool of claim 26, wherein the movable tray includes an upper horizontal surface when the movable tray is in the use position, and the upper horizontal surface defines at least one depression for receiving a can of paint on the upper horizontal surface.

28. The step stool of claim 27, wherein the clasp is adjacent the depression.

29. The step stool of claim 22, further comprising a lock for positively locking the movable tray in the use position.

30. The step stool of claim 29, wherein the fixed tray is formed to include an edge, and the lock comprises a tab coupled to the movable tray, the tab being configured to engage the edge, thereby holding the movable tray in the use position.

31. The step stool of claim 30, wherein the lock is disengaged from the edge by the application of lateral pressure.

32. The step stool of claim 30, wherein the lock can be accessed for disengagement from an upper surface of the fixed tray.
